(19) United States
(12) Patent Application Publication
(10) Pub. No.: US 2026/0062208 A1
(43) Pub. Date: Mar. 5, 2026

(54) Beverage Container Disposal Assembly

(71) Applicant: David Heisler, Jackson, NJ (US)

(72) Inventor: David Heisler, Jackson, NJ (US)

(21) Appl. No.: 18/817,415

(22) Filed: Aug. 28, 2024

(51) Int. Cl. B65F 1/14; B65F 1/16

(52) U.S. Cl. CPC B65F 1/1463; B65F 1/1431; B65F 1/1607

(57) ABSTRACT

A beverage container disposal assembly for efficient disposal of used cups includes a plurality of cups. A sleeve has an open top end. The plurality of cups is stackable within the sleeve through the open top end. The plurality of cups is nested within each other when the plurality of cups is stacked within the sleeve. A trash can is coupled to sleeve wherein the sleeve deposits the plurality of cups within the trash can while the plurality of cups are nested within each other. The trash can includes a base wall and a peripheral wall that extends upwardly from the base wall to define a trash can interior.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to trash containers and more particularly pertains to a new trash container for efficient disposal of used cups.

### (2) Description of Related Art including information disclosed under 37 CFR 1.97 and 1.98.

The prior art relates to trash containers. More particularly, the prior art relates to waste management for disposable cups. Disposable cups are used very commonly, in restaurants, workplaces, public gathering places such as churches and community centers, and even private homes. Disposable cups can take up a considerable amount of volume within waste containers. The prior art has accordingly disclosed trash compactors, which can crush the disposable cups and compact them into a smaller volume. However, trash compactors are expensive and are typically very noisy. The compacted trash can also be very heavy and difficult to handle when removing the compacted trash from the trash compactor. Thus, there is a need for a low-cost solution for disposing of cups that reduces the amount of volume the cups occupy in the trash can. Ideally, such a solution would be easy to implement in any place where disposable cups are used.

### BRIEF SUMMARY OF THE INVENTION

An embodiment of the disclosure meets the needs presented above by generally comprising a plurality of cups. A sleeve has an open top end. The plurality of cups is stackable within the sleeve through the open top end. The plurality of cups is nested within each other when the plurality of cups is stacked within the sleeve. A trash can is coupled to sleeve wherein the sleeve is configured to deposit the plurality of cups within the trash can while the plurality of cups are nested within each other. The trash can includes a base wall. A peripheral wall is coupled to and extends upwardly from the base wall to define a trash can interior. A top wall may be coupled to the peripheral wall distally to the base wall. A slot extends through the top wall into the trash can interior. The sleeve is aligned with the slot wherein the plurality of cups is positionable within the sleeve through the slot.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is a top exploded view of a beverage container disposal assembly according to an embodiment of the disclosure.

FIG. 2 is a front view of an embodiment of the disclosure.

FIG. 3 is a side view of an embodiment of the disclosure.

FIG. 4 is an in-use view of an embodiment of the disclosure.

FIG. 5 is a perspective view of an embodiment of the disclosure.

FIG. 6 is a perspective view of an embodiment of the disclosure.

FIG. 7 is a perspective view of an embodiment of the disclosure.

FIG. 8 is a front view of an embodiment of the disclosure.

FIG. 9 is a perspective view of an embodiment of the disclosure.

FIG. 10 is a front view of an embodiment of the disclosure.

FIG. 11 is a front view of an embodiment of the disclosure.

### DETAILED DESCRIPTION OF THE INVENTION

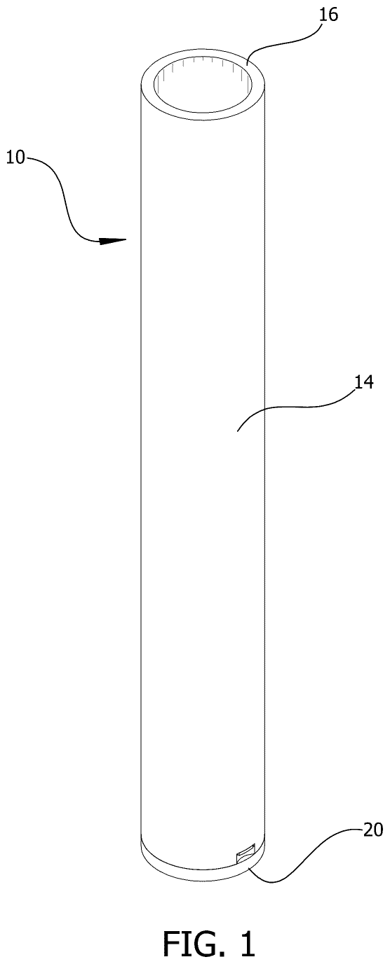

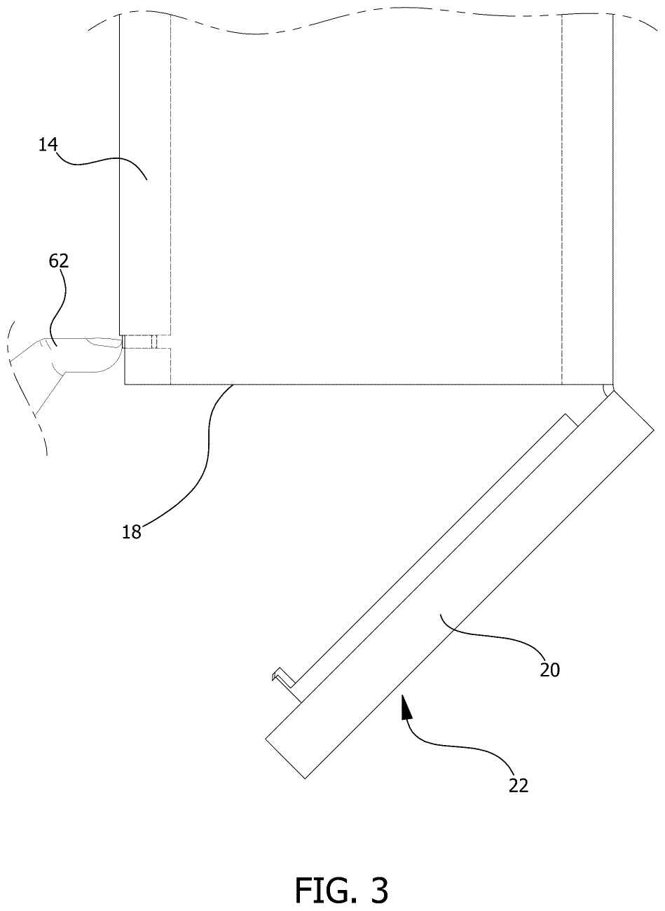

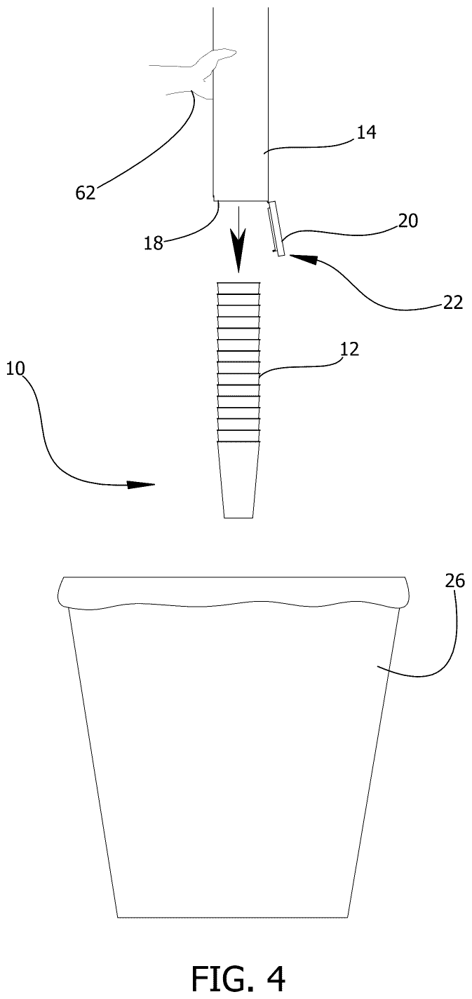

With reference now to the drawings, and in particular to FIGS. 1 through 11 thereof, a new trash container embodying the principles and concepts of an embodiment of the disclosure and generally designated by the reference numeral 10 will be described.

As best illustrated in FIGS. 1 through 11, the beverage container disposal assembly 10 generally comprises a plurality of cups 12. The plurality of cups 12 is generally disposable wherein each cup of the plurality of cups 12 configured for a single use. For example, the plurality of cups 12 may comprise paper or plastic materials.

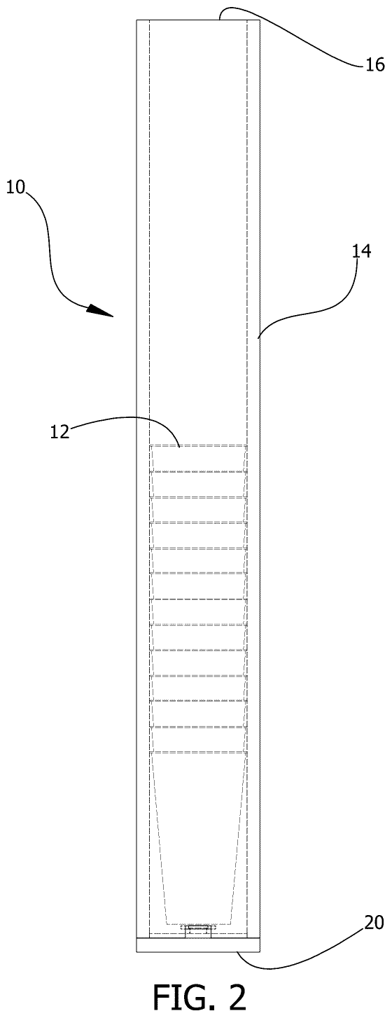

A sleeve 14 has an open top end 16. The sleeve 14 may also have an open bottom end 18. The sleeve 14 may be cylindrical and elongated wherein the plurality of cups 12 is positionable within the sleeve 14. The plurality of cups 12 is stackable within the sleeve 14 between the open top end 16 and the open bottom end 18. The plurality of cups 12 is nested within each other when the plurality of cups 12 is stacked within the sleeve 14 between the open bottom end 18 and the open top end 16, as shown in FIG. 2.

A cap 20 may be pivotably coupled to the sleeve 14. The cap 20 is positionable to cover the open bottom end 18 of the sleeve 14. For example, the cap 20 may be pivotable between an open position 22 and a closed position 24. The open bottom end 18 is exposed when the cap 20 is in the open position 22 wherein the open position 22 allows the plurality of cups 12 to be removed from the sleeve 14 through the open bottom end 18. The open bottom end 18 is covered by the cap 20 when the cap 20 is in the closed position 24 wherein the closed position 24 inhibits the plurality of cups 12 from being removed from the sleeve 14 through the open bottom end 18. A bottom-most cup of the plurality of cups 12 may rest on the cap 20 when the cap 20 is in the closed position 24. The cap 20 may be sealed wherein the cap 20 is configured to inhibit fluid penetration outwardly through the open bottom end 18 of the sleeve 14 when the cap 20 is in the closed position 24.

The sleeve 14 is generally configured to deposit the plurality of cups 12 within a trash can 26 while the plurality of cups 12 are nested within each other. The trash can 26 may be coupled to the sleeve 14. The trash can 26 may alternatively be removably couplable to the sleeve 14. For example, the sleeve 14 may be positionable within the trash can 26. The sleeve 14 is configured to facilitate stacking the plurality of cups 12 within the trash can 26 wherein the sleeve 14 is configured to reduce a volume of the plurality of cups 12 within the trash can 26. For example, when the plurality of cups 12 are stacked and nested within each other, the plurality of cups 12 generally occupies a smaller volume than the same plurality of cups 12 occupies when thrown away without being stacked.

The trash can 26 may include a base wall 28 and a peripheral wall 30 that is coupled to and extends upwardly from the base wall 28 to define a trash can interior 32. The peripheral wall 30 generally has an upper edge 34 that is distal to the base wall 28. The upper edge 34 may define an opening 66 into the trash can interior 32.

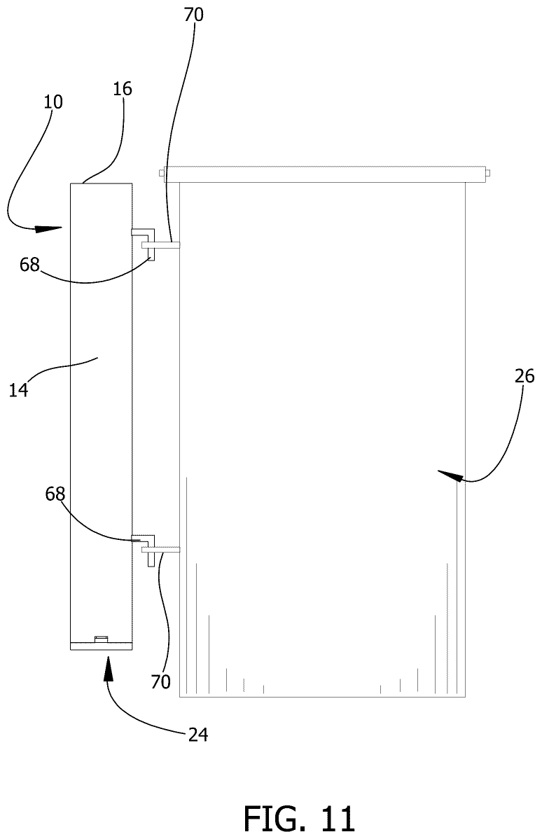

A hook 68 may be coupled to the sleeve 14. The hook 68 generally extends outwardly from the sleeve 14. For example, the hook 68 may be positionable on the upper edge 34 of the trash can 26 to removably couple the trash can 26 to the sleeve 14. As shown in FIG. 11, the hook 68 may be positionable on a bracket 70 that is coupled to and extends outwardly from the peripheral wall 30 of the trash can 26. Certain embodiments may include a pair of hooks 68 that are vertically aligned with each other along the length of the sleeve 14. Such embodiments may also include a pair of brackets 70 that are vertically aligned with each other along the peripheral wall 30 of the trash can 26.

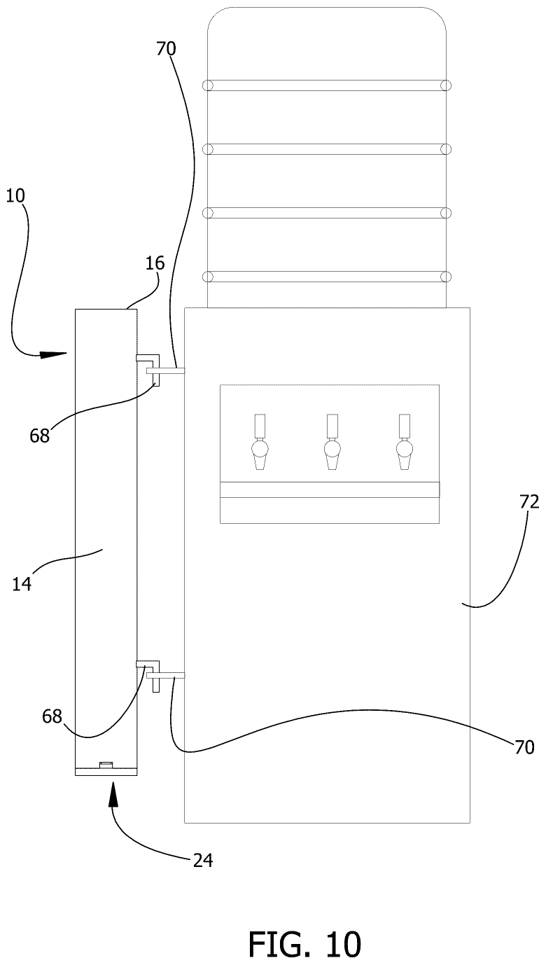

As shown in FIG. 10, the bracket 70 may be coupled to and extend outwardly from a water cooler 72. The sleeve 14 may be couplable to the water cooler 72 by positioning the hook 68 on the bracket 70. The plurality of cups 12 may be stacked within the sleeve 14 as the plurality of cups 12 are used at the water cooler 72. The sleeve 14 can be emptied into the trash can 26 once the sleeve 14 is filled.

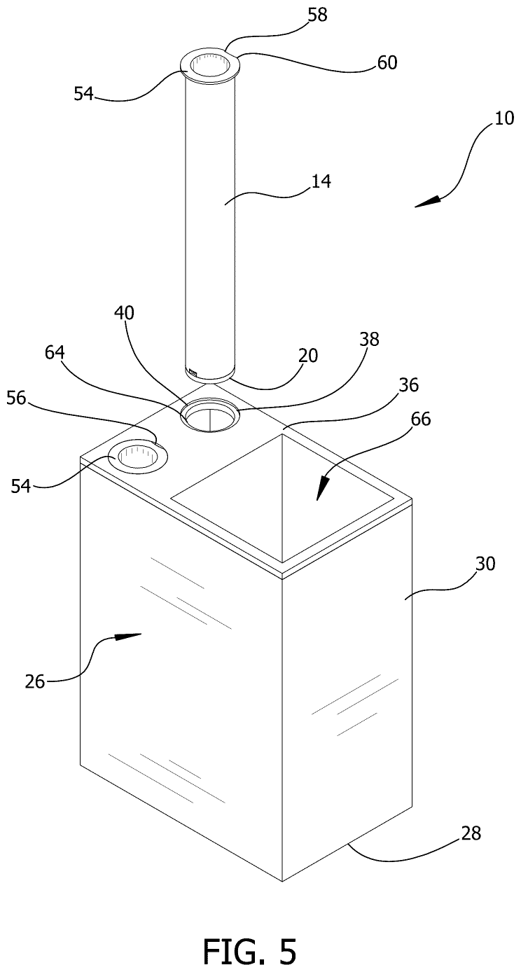

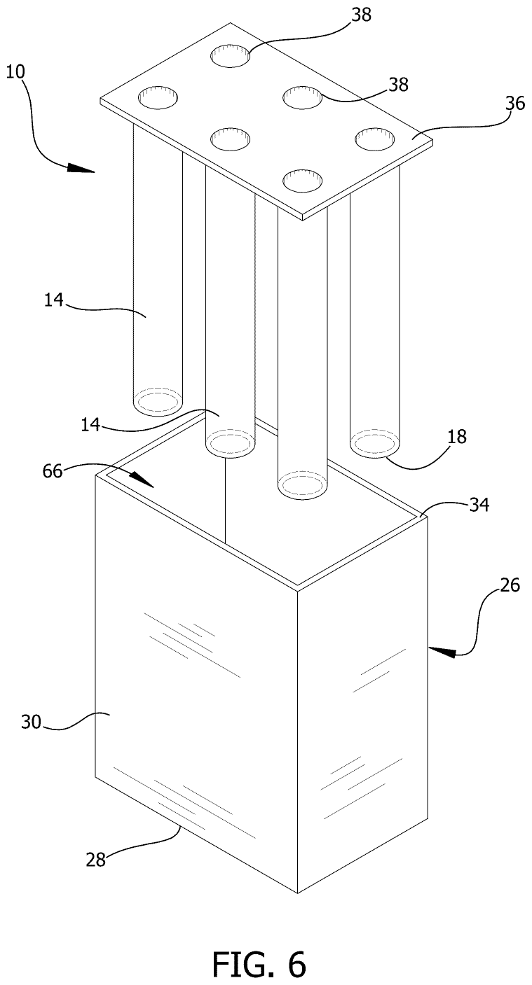

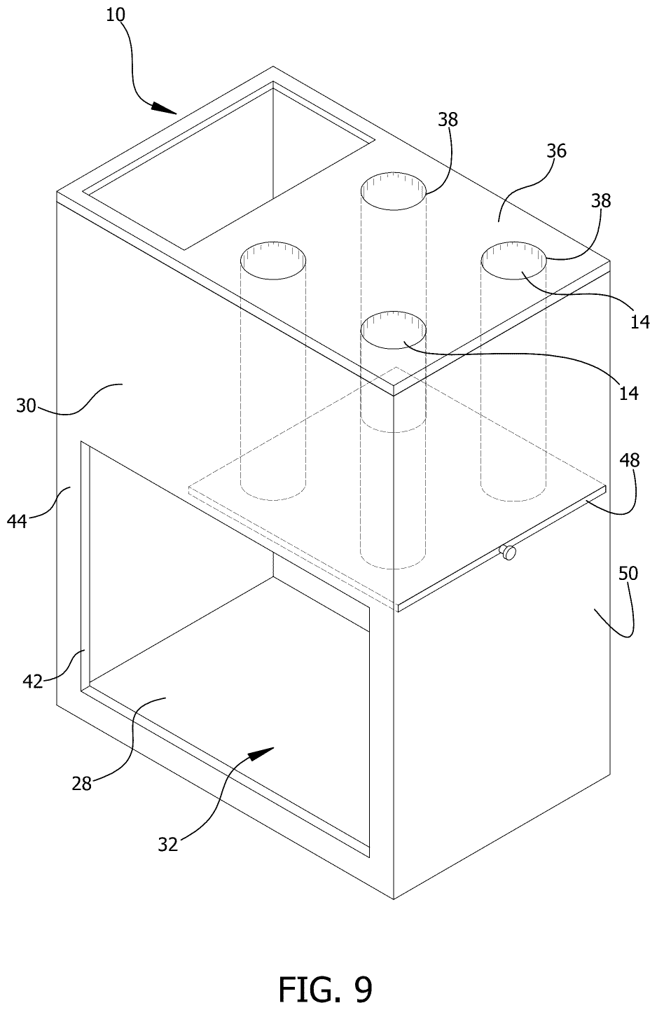

A top wall 36 may be coupled to, or removably couplable to, the peripheral wall 30 distally to the base wall 28. The top wall 36 may be positionable on the upper edge 34 of the peripheral wall 30 to selectively cover the opening 66 into the trash can interior 32. FIG. 6 provides an example of such embodiments. Alternatively, the opening 66 may extend through the top wall 36 into the trash can interior 32, as shown in FIGS. 5 and 9. For example, garbage items may be deposited directly into the trash can interior 32 through the opening 66 while the plurality of cups 12 are collected within the sleeve 14. The top wall 36 is generally removably couplable to the peripheral wall 30 in such embodiments, wherein the top wall 36 can be removed to empty the trash can 26 and the sleeve 14.

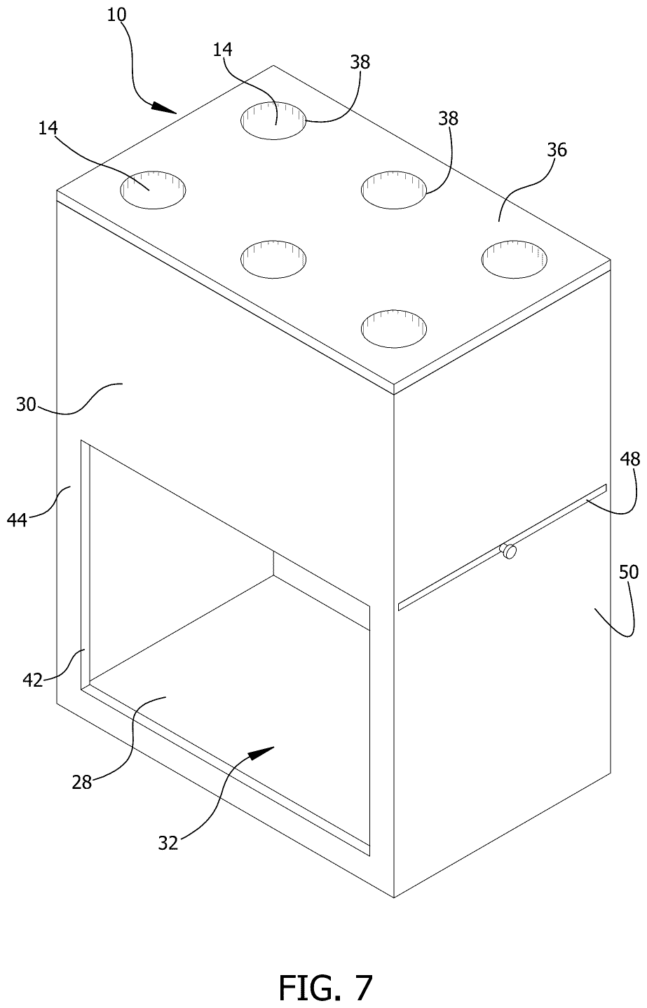

A plurality of slots 38 may extend through the top wall 36 into the trash can interior 32. Each slot of the plurality of slots 38 is generally spaced from an adjacent slot of the plurality of slots 38. The plurality of slots 38 is generally spaced from the opening 66 when the opening 66 extends through the top wall 36 of the trash can 26, as shown in FIG. 5. The plurality of slots 38 may include two slots, as shown in FIG. 5. A greater number of slots, such as the six slots shown in FIGS. 6 and 7, may also be included in the plurality of slots 38. In other embodiments, the plurality of slots 38 may include a single slot. Each slot of the plurality of slots 38 generally has a size and shape that is complementary to the size and shape of the sleeve 14 wherein each slot of the plurality of slots 38 is configured to receive the sleeve 14.

A plurality of channels 40 may extend into the top wall 36, as shown in FIG. 5. Each channel of the plurality of channels 40 is positioned around a respective slot of the plurality of slots 38 to define an overhang 64 extending into the respective slot. The sleeve 14 may hang from the overhang 64 when the sleeve 14 is inserted into the respective slot.

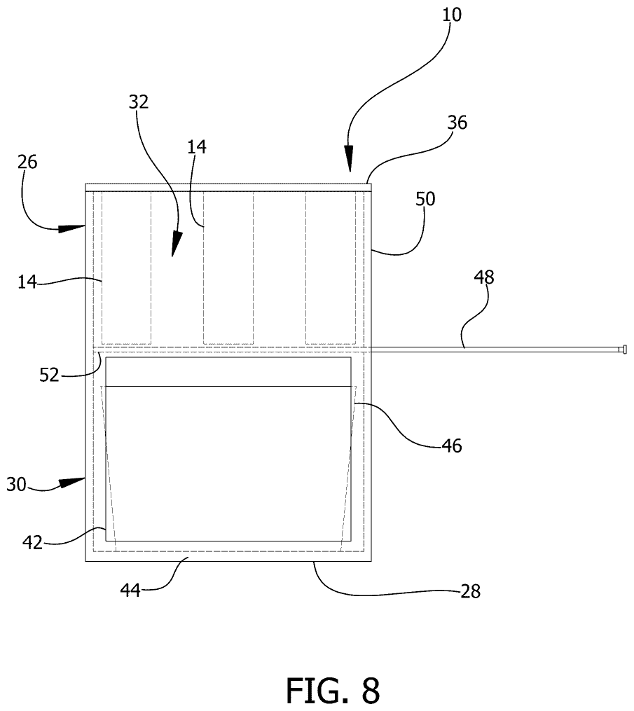

As shown in FIGS. 7-9, a cutout 42 may extend through the peripheral wall 30 into the trash can interior 32 wherein the cutout 42 is configured to receive a waste bin 46. For example, the cutout 42 may be positioned on a front side 44 of the peripheral wall 30. The cutout 42 may have a height that is less than a height of the peripheral wall 30 wherein the cutout 42 is spaced from the upper edge 34 of the peripheral wall 30 and wherein the sleeve 14 is positionable above the cutout 42 within the trash can 26. The cutout 42 is depicted as rectangular in FIGS. 7 and 8, although other shapes are also contemplated.

In such embodiments, a plate 48 may be removably couplable to the peripheral wall 30. For example, the plate 48 may be removably couplable to a lateral side 50 of the peripheral wall 30. The plate 48 is generally positioned above the cutout 42 wherein the plate 48 is positioned between the sleeve 14 and the cutout 42 within the trash can 26. The plate 48 is removable from the peripheral wall 30 to release the plurality of cups 12 from the sleeve 14 into the portion of the trash can interior 32 that is within the area of the cutout 42. The plurality of cups 12 is configured to fall from the sleeve 14 into the waste bin 46 when the plate 48 is removed from the peripheral wall 30. The plate 48 may be parallel to the base wall 28 when the plate 48 is coupled to the peripheral wall 30. The plate 48 may be equidistantly spaced from the base wall 28 and the top wall 36 when the plate 48 is coupled to the peripheral wall 30. Alternative positionings of the plate 48 relative to the base wall 28 and the top wall 26 are also contemplated, based on a desired length of the sleeve 14 and a desired number of the plurality of cups 12 that can be stacked within the sleeve 14.

A duct 52 may extend through the peripheral wall 30 into the trash can interior 32. For example, the duct 52 may be positioned on the lateral side 50 of the peripheral wall 30. The duct 52 generally has a shape that is complementary to a shape of the plate 48 wherein the duct 52 is configured to receive the plate 48. The plate 48 is slidable outwardly from the duct 52 to remove the plate 48 from the peripheral wall 30. The plate 48 is slidable inwardly through the duct 52 to couple the plate 48 to the peripheral wall 30.

In embodiments according to FIGS. 5-9, the sleeve 14 may further including a plurality of sleeves 14. The plurality of cups 12 is stackable within each sleeve 14 of the plurality of sleeves 14. Each sleeve 14 of the plurality of sleeves 14 is removably positionable within an associated slot of the plurality of slots 38.

As shown in FIG. 5, each sleeve 14 of the plurality of sleeves 14 may further include a lip 54 that extends outwardly from the sleeve 14. The lip 54 is generally positioned adjacent to the open top end 16. The lip 54 is positionable on the overhang 64 within the associated slot when the sleeve 14 is fully inserted into the associated slot of the plurality of slots 38. The lip 54 may have a height that is equal to a distance between the overhang 64 of the associated slot and the top wall 36 of the trash can 26 wherein the lip 54 is coplanar with the top wall 36 when the sleeve 14 is fully inserted into the associated slot.

A notch 56 may extend into the lip 54. The notch 56 may have a notch first edge 58 and a notch second edge 60. The notch 56 may be concavely arcuate between the notch first edge 58 and the notch second edge 60 wherein the notch 56 is configured to facilitate a user 62 in removing the sleeve 14 from the associated slot.

In embodiments according to FIG. 6, each sleeve 14 of the plurality of sleeves 14 may be coupled to the top wall 36 of the trash can 26 wherein each sleeve 14 of the plurality of sleeves 14 extends downwardly from the top wall 36 into the trash can interior 32. Each sleeve 14 of the plurality of sleeves 14 is aligned with an associated slot of the plurality of slots 38 wherein each sleeve 14 of the plurality of sleeves 14 is fluidly coupled to the associated slot of the plurality of slots 38. The plurality of slots 38 is configured to facilitate the user 62 in positioning the plurality of cups 12 within each sleeve 14 of the plurality of sleeves 14. The plurality of sleeves 14 may have a height that is complementary to a height of the trash can 26 wherein the plurality of sleeves 14 extend from the top wall 36 to the base wall 28 of the trash can 26 when the top wall 36 is positioned on the upper edge 34 of the peripheral wall 30. In such embodiments, the bottom-most cup of the plurality of cups 12 may rest on the base wall 28 when the top wall 36 is coupled to the peripheral wall 30.

In embodiments according to FIGS. 7 and 8, the plurality of sleeves 14 may have a height that is less than to a height of the trash can 26 wherein the plurality of sleeves 14 extend from the top wall 36 to the plate 48 within the trash can interior 32 the of the trash can 26 when the top wall 36 is positioned on the upper edge 34 of the peripheral wall 30. The bottom-most cup of the plurality of cups 12 may rest on the plate 48 when the top wall 36 is coupled to the peripheral wall 30.

In use, the user 62 can stack the plurality of cups 12 within the sleeve 14 when each cup of the plurality of cups 12 is thrown away. The plurality of cups 12 will be nested within the sleeve 14. In embodiments according to FIGS. 1-4, the user 62 can open the cap 20 and position the open bottom end 18 above the trash can 26 or waste bin 46 when the user 62 is ready to empty the sleeve 14. The plurality of cups 12 will remain stacked and neatly nested within each other as the plurality of cups 12 fall out of the open bottom end 18 into the trash can 26 or waste bin 46. The plurality of cups 12 will thus occupy relatively less volume in the trash can 26 or waste bin 46 than the same number of the plurality of cups 12 would occupy when they are not stacked and neatly nested within each other.

In embodiments according to FIG. 5, the user 62 can remove the sleeve 14 from the trash can 26, for example by using the notch 56 to facilitate the user 62 in gripping the lip 54. The user 62 can then open the cap 20 to expose the open bottom end above the trash can 26 so that the stack of the plurality of cups 12 can fall into the trash can 26.

In embodiments according to FIG. 6, the bottom-most cup of the plurality of cups 12 may rest on the base wall 28 of the trash can 26 as the plurality of cups 12 are stacked within the sleeve 14. The user 62 can simply lift the top wall 36 off of the upper edge 34 of the peripheral wall 30 so that the plurality of cups 12 can slide outwardly from the open bottom end 18 of the sleeve 14 into the trash can 26. Again, the plurality of cups 12 will remain neatly stacked and nested within each other to reduce the volume occupied by the plurality of cups within the trash can 26.

In embodiments according to FIGS. 7 and 8, the bottom-most cup of the plurality of cups 12 may rest on the plate 48 within the trash can interior 32 until the user 62 slides the plate 48 outwardly from the peripheral wall 30. The open bottom end 18 will then be exposed, allowing the plurality of cups 12 to fall into the waste bin 46 that is positioned within the cutout 42 below the plate 48.

In embodiments according to FIG. 9, the bottom-most cup of the plurality of cups 12 may rest on the base wall 28 of the trash can 26. The user 62 may deposit garbage, such as paper plates, napkins, or food waste, into the trash can interior 32 through the opening 66. To empty the plurality of sleeves 14 into the trash can interior 32, the top wall 36 of the trash can be lifted upwards to expose the open bottom end 18.

In embodiments according to FIG. 11, the sleeve 14 can be hung from the peripheral wall 30 of the trash can 26 using the hook 68 and the bracket 70. The sleeve 10 may also be hung from the upper edge 34 of the trash can 26 using the hook 68. As shown in FIG. 10, the sleeve 14 can also be removably coupled to other objects, such as the water cooler 72, using the hook 68 and the bracket 70. While the cap 20 is in the closed position 24, the plurality of cups 12 can be stacked within the sleeve 14. To empty the sleeve 14, the cap 20 can be pivoted to the open position 22 while the sleeve 14 is suspended over the opening 66 of the trash can 26.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

1. A cup disposal system comprising:
a plurality of cups;
a sleeve having an open top end, the plurality of cups being stackable within the sleeve through the open top end, the plurality of cups being nested within each other when the plurality of cups is stacked within the sleeve; and
a trash can being coupled to sleeve wherein the sleeve is configured to deposit the plurality of cups within the trash can while the plurality of cups are nested within each other, the trash can including:
a base wall;
a peripheral wall being coupled to and extending upwardly from the base wall to define a trash can interior;
a top wall being coupled to the peripheral wall distally to the base wall; and
a slot extending through the top wall into the trash can interior, the sleeve being aligned with the slot wherein the plurality of cups is positionable within the sleeve through the slot.

2. The cup disposal system of claim 1, the trash can further comprising a channel extending into the top wall, the channel being positioned around the slot to define an overhang extending into the slot, the sleeve being hung from the overhang when the sleeve is positioned in the slot.

3. The cup disposal system of claim 2, the sleeve further comprising a lip extending outwardly from the sleeve, the lip being positioned adjacent to the open top end wherein the lip is positionable on the overhang within the slot when the sleeve is fully inserted into the slot.

4. The cup disposal system of claim 3, wherein the lip has a height that is equal to a distance between the overhang of the slot and the top wall of the trash can wherein the lip is coplanar with the top wall when the sleeve is fully inserted into the slot.

5. The cup disposal system of claim 3, the sleeve further comprising a notch extending into the lip, the notch having a notch first edge and a notch second edge, the notch being concavely arcuate between the notch first edge and the notch second edge wherein the notch is configured to facilitate a user in removing the sleeve from the slot.

6. The cup disposal system of claim 1, the sleeve further comprising an open bottom end, the plurality of cups being deposited into the trash can through the open bottom end while the plurality of cups are nested within each other.

7. The cup disposal system of claim 6, further comprising a cap being pivotably coupled to the sleeve, the cap being positionable to cover the open bottom end of the sleeve.

8. The cup disposal system of claim 7, wherein the cap is pivotable between an open position and a closed position, the open bottom end being exposed when the cap is in the open position wherein the open position allows the plurality of cups to be removed from the sleeve through the open bottom end, the open bottom end being covered by the cap when the cap is in the closed position wherein the closed position inhibits the plurality of cups from being removed from the sleeve through the open bottom end.

9. The cup disposal system of claim 8, wherein a bottom-most cup of the plurality of cups rests on the cap when the cap is in the closed position.

10. The cup disposal system of claim 7, wherein the cap is sealed wherein the cap is configured to inhibit fluid penetration outwardly through the open bottom end of the sleeve when the cap is positioned to cover the open bottom end of the sleeve.

11. The cup disposal system of claim 1, the trash can further comprising:
a cutout extending through the peripheral wall into the trash can interior wherein the cutout is configured to receive a waste bin, the cutout having a height being less than a height of the peripheral wall wherein the cutout is spaced from the upper edge of the peripheral wall and wherein the sleeve is positionable above the cutout within the trash can;
a plate being removably couplable to the peripheral wall, the plate being positioned above the cutout wherein the plate is positionable between the sleeve and the cutout within the trash can, a bottom-most one of the plurality of cups resting on the plate when the plate is positioned between the sleeve and the cutout, the plate being removable from the peripheral wall to release the plurality of cups from the sleeve into the cutout wherein the plurality of cups is configured to fall from the sleeve into the waste bin when the plate is removed from the peripheral wall.

12. The cup disposal system of claim 11, the trash can further comprising a duct extending through the peripheral wall into the trash can interior, the duct having a shape being complementary to a shape of the plate wherein the duct is configured to receive the plate.

13. The cup disposal system of claim 11, the sleeve further comprising a plurality of sleeves, the plurality of cups being stackable within each sleeve of the plurality of sleeves, each sleeve of the plurality of sleeves being coupled to the top wall of the trash can wherein each sleeve of the plurality of sleeves extends downwardly from the top wall into the trash can interior, the slot of the trash can further comprising a plurality of slots, the open top end of each sleeve of the plurality of sleeves being aligned with an associated slot of the plurality of slots wherein the plurality of slots is configured to facilitate a user in positioning the plurality of cups within each sleeve of the plurality of sleeves.

14. The cup disposal system of claim 13, wherein each sleeve of the plurality of sleeves has a height being less than a distance between the top wall and the plate wherein the plurality of sleeves extend from the top wall to the plate within the trash can interior the of the trash can.

15. The cup disposal system of claim 1, the sleeve further including a plurality of sleeves, the plurality of cups being stackable within each sleeve of the plurality of sleeves, each sleeve of the plurality of sleeves being coupled to the top wall of the trash can wherein each sleeve of the plurality of sleeves extends downwardly from the top wall into the trash can interior, the slot of the trash can further comprising a plurality of slots, each sleeve of the plurality of sleeves being aligned with an associated slot of the plurality of slots wherein the plurality of slots is configured to facilitate a user in positioning the plurality of cups within each sleeve of the plurality of sleeves.

16. The cup disposal system of claim 15, wherein each sleeve of the plurality of sleeves has a height being complementary to a height of the trash can wherein the plurality of sleeves extend from the top wall to the base wall of the trash can.

17. The cup disposal system of claim 1, wherein the sleeve is removably couplable to the top wall of the trash can.

18. The cup disposal system of claim 1, wherein the sleeve is attached to the top wall of the trash can.

19. A cup disposal system comprising:
a plurality of cups;
a sleeve having an open top end and an open bottom end, the sleeve being cylindrical, the sleeve being elongated wherein the plurality of cups is positionable within the sleeve, the plurality of cups being stackable within the sleeve between the open top end and the open bottom end, the plurality of cups being nested within each other when the plurality of cups is stacked within the sleeve between the open bottom end and the open top end;
a cap being pivotably coupled to the sleeve, the cap being positionable to cover the open bottom end of the sleeve, the cap being pivotable between an open position and a closed position, the open bottom end being exposed when the cap is in the open position wherein the open position allows the plurality of cups to be removed from the sleeve through the open bottom end, the open bottom end being covered by the cap when the cap is in the closed position wherein the closed position inhibits the plurality of cups from being removed from the sleeve through the open bottom end, the cap being sealed wherein the cap is configured to inhibit fluid penetration outwardly through the open bottom end of the sleeve when the cap is in the closed position, a bottom-most cup of the plurality of cups resting on the cap when the cap is in the closed position;
a trash can being removably couplable to the sleeve wherein the sleeve is positionable within the trash can and wherein the sleeve is configured to deposit the plurality of cups within the trash can while the plurality of cups are nested within each other, the trash can including:
a base wall;
a peripheral wall being coupled to and extending upwardly from the base wall to define a trash can interior;
a top wall being coupled to the peripheral wall distally to the base wall;
an opening extending through the top wall into the trash can interior;
a plurality of slots extending through the top wall into the trash can interior, each slot of the plurality of slots being spaced from an adjacent slot of the plurality of slots, each slot of the plurality of slots being spaced from the opening; and
a plurality of channels extending into the top wall, each channel of the plurality of channels being positioned around a respective slot of the plurality of slots to define an overhang extending into the respective slot;
the sleeve further including a plurality of sleeves, the plurality of cups being stackable within each sleeve of the plurality of sleeves, each sleeve of the plurality of sleeves being removably positionable within an associated slot of the plurality of slots, each sleeve of the plurality of sleeves further including:
a lip extending outwardly from the sleeve, the lip being positioned adjacent to the open top end wherein the lip is positionable on the overhang within the associated slot when the sleeve is fully inserted into the associated slot, the lip having a height being equal to a distance between the overhang of the associated slot and the top wall of the trash can wherein the lip is coplanar with the top wall when the sleeve is fully inserted into the associated slot; and
a notch extending into the lip, the notch having a notch first edge and a notch second edge, the notch being concavely arcuate between the notch first edge and the notch second edge wherein the notch is configured to facilitate a user in removing the sleeve from the associated slot.
